(19) United States
(12) Patent Application Publication
(10) Pub. No.: US 2009/0028977 A1
(43) Pub. Date: Jan. 29, 2009

(54) Extrusion Method and Extrusion Device

(75) Inventor: Kari Kirjavainen, Tampere (FI)

Correspondence Address: OLIFF & BERRIDGE, PLC, P.O. BOX 320850, ALEXANDRIA, VA, 22320-4850, US

(73) Assignee: MAILLEFER S.A., Ecublens (CH)

(21) Appl. No.: 11/922,696

(22) PCT Filed: Jul. 3, 2006
(86) PCT No.: PCT/FI2006/050307

§ 371 Date: Dec. 21, 2007

(30) Foreign Application Priority Data
Jul. 4, 2005 (FI) 20055386

(51) Int. Cl. B29C 47/36; B28B 21/52

(52) U.S. Cl. 425/204; 425/381

(57) ABSTRACT

Material is extruded with a device comprising at least two stators (1,2) one within the other and, between them, a rotor (3) in the shape of a convergent cone, the material being extruded from the device by rotating the rotor (3). The rotor (3) comprises openings (9), through which the material is led. The stators (1,2) comprise continuous grooves (8) for conveying the material out of the device. The stator grooves (8) alternately become lower and deeper, said grooves (8) being arranged such that when the groove of the inner stator (1) is low, the point of the groove of the outer stator (2) on the other side of the rotor (3) at a corresponding point is deep and vice versa.

### BACKGROUND OF THE INVENTION

The invention relates to an extrusion method, in which method material is extruded with a device comprising at least two stators one within another and, between them, a rotor in the shape of a convergent cone, the material being extruded from the device by rotating the rotor.

The invention further relates to an extrusion device comprising at least two stators one within the other and, between them, a rotor in the shape of a convergent cone.

WO publication 99/11374 discloses a solution for treating waste material. The waste material is treated in an apparatus comprising a conical rotatable rotor placed between stators. The stators are provided with recesses by means of which the material is extruded from the device when the rotor is rotated. The rotor comprises openings through which the material is arranged to flow. The edges of the recesses and openings are sharp in such a manner that the waste material led to the apparatus is ground by the action of the sharp edges when the waste material passes through the openings.

WO publication 01/70486 discloses a method and an apparatus for extruding material. Extrusion takes place with an apparatus comprising at least one rotatable rotor and at least one stator. The rotor and the stator are provided with grooves that move the material through the apparatus when the rotor is rotated. The rotor and the stator are provided with surfaces that face each other and have a wavelike cross-section. The grooves are arranged in such a manner that at the ridge of a wave the depth of a groove is at its maximum and at the bottom of a wave the depth of a groove is at its minimum. Furthermore, the bottom of a wave in the rotor is at the ridge of a wave in the stator and vice versa. This makes the material move alternately from a rotor groove to a stator groove and back.

WO publication 03/000393 discloses a method and an apparatus for processing material. The material is processed in an apparatus comprising at least two annular feed gaps arranged one within the other. The beginning of each feed gap is provided with a grinding section. The grinding sections are followed by a mixing section. In the grinding section, the rotor and stator surfaces facing each other have a wavelike cross-section. In the mixing section following the grinding section, holes are arranged through the rotor.

### BRIEF DESCRIPTION OF THE INVENTION

The object of the present invention is to provide a new type of extrusion method and extrusion device.

The method of the invention is characterized by the stators comprising continuous grooves, by means of which material is conveyed out of the device, the grooves alternately becoming lower and deeper, said stator grooves being arranged such that when a groove of the inner stator is low, the point of the groove of the outer stator on the other side of the rotor at a corresponding point is deep and vice versa, and part of the material being led by means of the stator grooves that become lower through openings provided in the rotor.

The device of the invention is characterized in that the stators comprise continuous grooves for conveying the material out of the device, the grooves alternately becoming lower and deeper, that said stator grooves are arranged such that when the groove of the inner stator is low, the point of the groove of the outer stator on the other side of the rotor at a corresponding point is deep and vice versa, and that the rotor comprises openings, through which part of the material is led.

The idea of the invention is to extrude material with a device comprising at least two stators and, between them, at least one conical rotatable rotor. The rotor is provided with holes, through which the material is led. The stator is provided with continuous spiral grooves, which alternately become deeper and lower, preferably becoming wider when becoming deeper, and becoming narrower when becoming lower. When the spiral grooves are continuous, not all material is led through the holes in rotor, but the flow is divided. This improves the mixing of the material. Thanks to the rotor holes, the pressure forces are evened out on the different sides of the rotor. Furthermore, when a groove in the inner stator is at its lowest, the groove at a corresponding point of the outer stator is at its deepest, thus avoiding extensive pressure variation.

The idea of an embodiment is that the openings in the rotor are elongated and arranged in a diagonal position crosswise relative to the stator grooves. This being so, the pressure generation capability of the device is extremely good and the mixing performance of the device is also good. Accordingly, this enables the combination of an extremely good mixing property and a good flow generation ability in the same device, since all of the rotor openings and the stator openings lead the flow forward.

The idea of another embodiment is that the rotor openings are interconnected with flow channels, i.e. grooves are arranged in the rotor from one opening to another. The grooves are preferably alternately on different sides of the rotor. Thanks to the flow channels in the rotor, the continuity of the flow is maintained, and the flow does not come to a stop in the apparatus.

### BRIEF DESCRIPTION OF THE FIGURES

The invention will be described in more detail in the accompanying drawings, wherein

FIG. 1 is a schematic side view in section of an extrusion device;

FIG. 2 schematically shows an inner stator of an extrusion device;

FIG. 3 schematically shows a rotor of an extrusion device; and

FIG. 4 schematically shows the passage of material in an extrusion device.

For the sake of clarity, some embodiments of the invention are described in a simplified manner. Like parts are denoted with the same reference numerals in the figures.

### DETAILED DESCRIPTION OF SOME EMBODIMENTS OF THE INVENTION

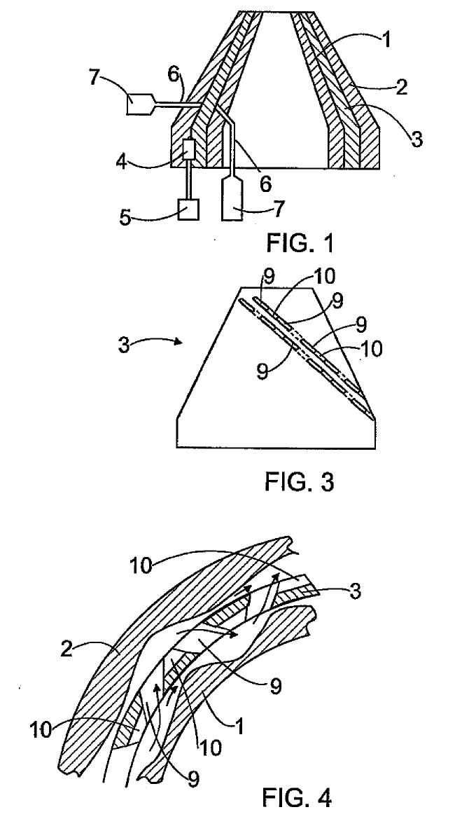

FIG. 1 is a side view in section of an extrusion device. The device comprises an inner stator 1 and an outer stator 2 arranged outside thereof. At least the outer surface of the inner stator 1 and the inner surface of the outer stator 2 are in the shape of a convergent cone. A rotor 3 in the shape of a convergent cone is arranged between the inner stator 1 and the outer stator 2. The rotor 3 is arranged to move rotationally between the inner stator 1 and the outer 2. The rotor 3 is rotated with a motor 5. The motor 5 may be for instance a hydraulic motor, electromotor or some other motor fully known per se and suitable for the purpose. The motor 5 is arranged to rotate the rotor 3 via a gear system 4. The speed of rotation of the rotor 3 can be adjusted in the desired manner by means of the gear system 4. On the other hand, when an electromotor, for example, is used, the gear system 4 is not necessary, since the speed of rotation of the rotor 3 can be easily adjusted by adjusting the speed of rotation of the motor 5 in a manner fully known per se.

Furthermore, the device is provided with a feed channel 6, along which the material to be processed is fed to the apparatus. The material fed to the feed channel 6 is fed with a feeding device 7. The feeding device 7 may be for instance a feed screw, a feeder pump, or another device fully known per se. Said feeding device enables the adjustment of the flow amount of the material to be fed to the feed channel. The material may be fed along different feed channels 6 to the outside and inside of the rotor 3, as is shown in FIG. 1. On the other hand, it is also possible to provide the rotor 3 with feed openings and to feed the material to the outside of the rotor, part of the material being conveyed through the feed openings to the inside of the rotor.

For the sake of clarity, FIG. 1 does not show the grooves of the stator 1 and 2 or the openings and grooves of the rotor 3.

FIG. 2 shows an inner stator 1. The inner stator 1 is provided with continuous grooves 8 that lead material outwards from the device as the rotor 3 is rotating. The grooves 8 are arranged such that they alternately become lower and deeper. At the same time as the grooves 8 become lower, they also become narrower and when they become deeper, then they become wider at the same time, whereby the machining of the grooves 8 to the stator is simpler. Reference numeral 8a denotes a narrower and lower point of a groove and reference numeral 8b denotes a deeper and wider point of a groove.

The outer stator 2 is arranged similar, i.e. in the outer stator 2, the grooves are in the same direction as in the inner stator 1. Furthermore, the grooves of the outer stator 2 are arranged such that at the point 8a of a low and narrow groove in the inner stator 1, the outer stator is provided with a deep and wide groove. Similarly, at the point 8b of a deep and wide groove in the inner stator 1 is a low and narrow point of a groove in the outer stator.

FIG. 3 shows a rotor 3. The rotor 3 comprises through-going openings 9. The openings 9 are elongated and arranged diagonal relative to the horizontal plane in accordance with FIG. 3. Further, the rotor 3 is rotated such that also the openings 9 lead material outwards from the device.

The openings 9 are interconnected with flow channels 10. A flow channel 10 is a groove on the surface of the rotor 3 and leads from one opening to another. The flow channel 10 is arranged alternately on the inner and outer side of the rotor. In FIG. 3, flow channels 10 on the inside of the rotor 3 are denoted with broken lines. For the sake of clarity, FIG. 3 only shows part of the openings 9 of the rotor 3. The openings 9 are naturally arranged everywhere throughout the rotor 3.

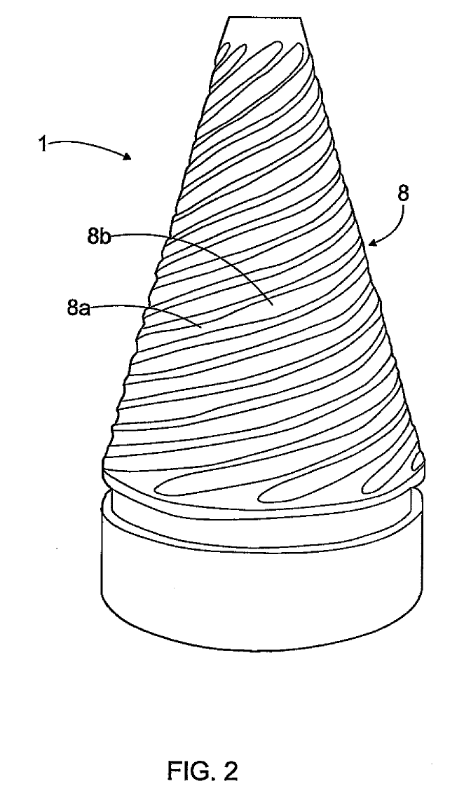

FIG. 4 illustrates how material flows in the device. Since the stator grooves 8 are continuous, the flow is divided such that only part of the material passes through the opening 9 and part thereof continues forwards between the stator and the rotor. This generates an extremely efficient mixing. On the other hand, the openings 9 even out the pressures on the different sides of the rotor 3. Furthermore, the grooves of the inner stator 1 and the grooves of the outer stator 2 are arranged such that when a groove of the inner stator is at its minimum, the groove of the outer stator is at its maximum and vice versa. Accordingly, the material is allowed to pass smoothly forward in the apparatus. For their part, the flow channels 10 between the openings 9 enable a continuous flow. The arrangement of the flow channel 10 alternately on the inside and outside of the rotor increases the mixing efficiency of the device.

Furthermore, the end edges of the openings 9 are arranged slanted. This being so, a smooth material flow is accomplished, and dead regions, wherein the material would accumulate, are not formed on the trailing side of the opening 9, for example. The slanted parts can be arranged for instance such that in one of the opening arrays illustrated in FIG. 3, the slanted parts are in the same direction, and in the next adjacent opening array, the slanted parts are in the opposite direction. The slanted parts can be arranged to observe the variation in the depths of the stator grooves 8 in accordance with FIG. 4.

The edges of the rotor 3 openings 9 and/or the rotor flow channels 10 and/or the stator grooves 8 are preferably sharp such that they cut the material thus enhancing the grinding of the material. The edges of the openings 9 and/or the grooves 8 thus cut and grind the material.

The device presented is suitable for the extrusion of plastics, such as polyolefins, for example. Furthermore, the device can be used for the extrusion of composite products, whereby wood fibre material, such as sawdust, for example, and a binding agent, for instance plastic, are fed to the device. In addition, different additives and auxiliary substances can naturally be fed to the device at the same time. The device can also be used for the extrusion of recycled materials. The device is particularly well suitable for use in applications wherein the materials are to be mixed efficiently in the extrusion device.

In some cases, the characteristics described in the present application can be used as such, irrespective of the other characteristics. On the other hand, the characteristics described in the present application can be combined to generate different combination, if need be.

The drawings and the related description are only intended to illustrate the idea of the invention. The details of the invention may vary within the scope of the claims. The rotor 3 may also comprise grooves that convey the flow forwards; the edges of the grooves may be sharp for cutting and grinding the material.

1-13. (canceled)

14. An extrusion method comprising extruding material with a device comprising at least two stators one within the other and, between them, a rotor in the shape of a convergent cone, the material being extruded from the device by rotating the rotor, the stators comprising continuous grooves, by means of which material is conveyed out of the device, the grooves alternately becoming lower and deeper, said stator grooves being arranged such that when a groove of the inner stator is low, the point of the groove of the outer stator on the other side of the rotor at a corresponding point is deep and vice versa, and leading part of the material by means of the stator grooves that become lower through openings provided in the rotor.

15. A method as claimed in claim 14, wherein when the stator groove becomes lower, it becomes narrower and when it becomes deeper, it becomes wider.

16. A method as claimed in claim 14, wherein the rotor openings are elongated and arranged diagonally and crosswise relative to the stator grooves, whereby, when the rotor rotates, the stator grooves and the rotor openings convey material out of the device.

17. A method as claimed in claim 14, wherein the rotor openings are connected with flow channels, whereby material is conveyed forwards in the rotor along the flow channels from one opening to another.

18. A method as claimed in claim 14, wherein the edges of the rotor openings and/or the stator grooves are sharp, whereby they cut and grind the material.

19. A method as claimed in claim 14, wherein the ends of the openings are arranged slanted, whereby they lead the material flow smoothly.

20. An extrusion device comprising at least two stators one within the other and, between them, a rotor in the shape of a convergent cone, wherein the stators comprise continuous grooves for conveying the material out of the device, the grooves alternately becoming lower and deeper, that said stator grooves being arranged such that when the groove of the inner stator is low, the point of the groove of the outer stator on the other side of the rotor at a corresponding point is deep and vice versa, and the rotor comprising openings, through which part of the material is led.

21. A device as claimed in claim 20, wherein when the stator groove becomes lower, it becomes narrower, and when becoming deeper, it becomes wider.

22. A device as claimed in claim 20, wherein the rotor openings are elongated and arranged diagonally and crosswise relative to the stator grooves, whereby, when the rotor rotates, the stator grooves and the rotor openings convey material out of the device.

23. A device as claimed in claim 20, wherein the rotor surface is provided with flow channels from one opening to another.

24. A device as claimed in claim 23, wherein the flow channels are arranged alternately on the inside and the outside of the rotor.

25. A device as claimed in claim 20, wherein the edges of the rotor openings and/or the stator grooves are sharp for cutting and grinding the material.

26. A device as claimed in claim 20, wherein the ends of the openings are arranged slanted.
